(19) United States
(12) Patent Application Publication
(10) Pub. No.: US 2013/0110595 A1
(43) Pub. Date: May 2, 2013

(54) METHOD OF ACKNOWLEDGING VIEWING OF AN ADVERTISEMENT, MONETIZING AND CONDUCTING REFERENDUMS

(71) Applicant: Jesus Acosta-Cazaubon, Atlanta, GA (US)

(72) Inventor: Jesus Acosta-Cazaubon, Atlanta, GA (US)

(21) Appl. No.: 13/366,581

(22) Filed: Feb. 6, 2012

Related U.S. Application Data
(60) Provisional application No. 61/553,290, filed on Oct. 31, 2011.

(51) Int. Cl. G06Q 30/02

(52) U.S. Cl. 705/14.7; 705/14.69

(57) ABSTRACT

The present invention is directed toward a method for generating revenue utilizing a referendum service provider to provide referendums through interfaces. Each referendum includes two answers, one of which is to be selected by a user. The referendum service provider receives and stores a first token generated as a result of a request for a referendum to be displayed on the interface. The referendum service provider responds to the request by sending a referendum to be displayed on the interface. This is followed by the user selecting one of the two answers presented to the user. A second token generated as a result of the selection of one of the two answers is sent with the answer to the referendum service provider. The second token is then compared to the first token to produce a result, wherein if the result indicates a match, the referendum service provider is compensated.

### RELATED APPLICATIONS AND PRIORITY CLAIM

This application claims priority to provisional application U.S. Ser. No. 61/553,290 filed Oct. 31, 2011. Said application is incorporated by reference herein in its entirety.

### BACKGROUND OF THE INVENTION

1. The Field of the Invention The present invention is directed generally to serving online referendums. More specifically, the present invention is directed to monetizing online referendums served alone or monetizing online referendums that are combined with one or more advertisements by providing a method for simultaneously collecting data associated with viewer acknowledgment of an advertisement and referendum data.

2. Background Art

Online advertising has been practiced for a number of years and has been a catalyst for content generation on the internet. One pervasive advertising strategy has been to provide advertisements related to the contents of a search result of a search engine. Various search engine and mobile application providers have been able to generate revenue by providing advertisements through software applications, e.g., search engines, free-of-charge game applications, etc. on user devices such as computers, mobile phones, pads, and the like. Typically, a request, e.g., a search request or a request for a game or application, is placed through user devices via processes associated with Hypertext Markup Language (HTML) and Hypertext Transfer Protocol (HTTP). One or more advertisements are transmitted to and displayed on user devices alongside the contents requested. The online advertising industry utilizes a pay-per-impression (PPI) or pay-per-click (PPC) model. In carrying out PPI and PPC, an advertiser engages an advertising facilitator such as Google, Yahoo or Bing to serve up advertisements when relevant contents for such advertisements are requested. An impression is a display of an advertisement on a user device. In general, an advertiser is willing to pay for impressions if the aim is merely to increase brand awareness as the cost associated with displaying an advertisement is generally low. In PPC, an advertiser typically provides a link which upon being clicked, connects the user to a website specified by the advertiser. PPC generally costs more as the likelihood that such practice will produce tangible financial return is increased as a click of a link typically implies increased level of interest in the user of the product or service being advertised.

One disadvantage of such an advertisement lies in its inability in garnering attention as users have grown accustomed to seeing these advertisements or they dislike being redirected to a second website either within the same display window or a second display window. Moreover, advertisements that are of static images type do not possess a mechanism for acknowledging whether the advertisements have been viewed. An advertising facilitator such as Google® has also provided ways for a user to customized advertisements served with a search result such that more targeted advertisements appear in search results. This further demonstrates a need in the internet industry to provide relevant, interesting and fresh content, including advertisements or referendums. To solve this problem, an increasing number of advertisers have now started to use short videos to engage users. Typically, the click of a button is required to start playing a video advertisement. There is no indication of the amount of retention the video advertisements have on users. The users can click to play the video advertisements without paying attention to the contents. Therefore, there lacks an advertising mechanism that garners attention and provides a tangible proof to advertisers that viewership of their advertisements is increased.

Thus, there arises a need for a mechanism to enhance the ability to determine viewership of a referendum served alone or served in conjunction with an advertisement. This will enable service providers to generate revenue and advertisers to qualify the effectiveness of the service.

### SUMMARY OF THE INVENTION

The present invention is directed toward a method for generating revenue utilizing a referendum service provider to provide a referendum through an interface. Each referendum includes two answers, where one of which is to be selected by a user. The referendum service provider receives and stores a first token generated as a result of a request for a referendum to be displayed on the interface. The referendum service provider responds to the request by sending a referendum to be displayed on the interface. This is followed by the user selecting one of the two answers presented to the user. A second token generated as a result of the selection of one of the two answers is sent with the answer to the referendum service provider. The second token is then compared to the first token to produce a result, wherein if the result indicates a match, the referendum service provider is financially compensated.

Accordingly, it is a primary object of the present invention to provide a mechanism for acknowledging viewing of an advertisement while enabling collection of referendum data simultaneously.

It is yet a further object of the present invention to enable referendum service providers or advertisement facilitators to increase their revenue by providing additional services to advertisers to increase viewership of advertisements and/or referendums and collect referendum results and provide them to advertisers at the same time.

It is another object of the present invention to enable advertisers to utilize referendums to imply viewership of advisements to which they are coupled.

It is another object of the present invention to enable advertisers to combine the use of referendums and advertisements to increase viewership of the advertisements and/or the referendums.

It is another object to provide a means for engaging users that is different than ubiquitous advertisements.

It is another object to provide a means for engaging users of an online application or search engine.

Whereas there may be many embodiments of the present invention, each embodiment may meet one or more of the foregoing recited objects in any combination. It is not intended that each embodiment will necessarily meet each objective. Thus, having broadly outlined the more important features of the present invention in order that the detailed description thereof may be better understood, and that the present contribution to the art may be better appreciated, there are, of course, additional features of the present invention that will be described herein and will form a part of the subject matter of this specification.

### BRIEF DESCRIPTION OF THE DRAWINGS

In order that the manner in which the above-recited and other advantages and objects of the invention are obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a block diagram depicting one embodiment of an exemplary advertising system utilizing a combined display of advertisements and referendums.

FIG. 2 depicts an exemplary combined display of an advertisement and a referendum on a mobile computing device.

FIG. 3 depicts an exemplary display of a referendum on a mobile computing device.

FIG. 4 is a sequence diagram depicting an exemplary advertising payment system where a referendum service provider and an advertising facilitator are operably distinct systems.

FIG. 4A is a sequence diagram depicting an exemplary advertising payment system which relates the viewing of an advertisement to a means for communicating reward through a referendum.

FIG. 5 is a sequence diagram depicting an exemplary advertising payment system with alternate handshakes between a user device, an advertising facilitator and a referendum service provider and where a referendum service provider and an advertising facilitator are operably distinct systems.

FIG. 6 is a sequence diagram depicting an exemplary advertising payment system where a referendum service provider is integral to an advertising facilitator.

FIG. 7 is a sequence diagram depicting a referendum service of an exemplary advertising payment system.

FIG. 7A is a sequence diagram depicting a referendum service of yet another exemplary advertising payment system.

FIG. 7B is a sequence diagram depicting a referendum service of FIG. 7A wherein a second advertising facilitator is used to serve referendums.

FIG. 8 is a sequence diagram depicting another embodiment of a referendum service of an exemplary advertising payment system.

FIG. 9 is a flowchart depicting a means for monetizing a referendum.

### PARTS LIST

2—advertisement advertiser
3—advertisement and referendum advertiser
4—referendum advertiser
6—referendum service provider
8—advertising facilitator
10—user device
12—user
14—internet
16—referendum pool server
18—advertising facilitator database
20—advertisement banner
22—referendum banner
24—referendum answer
25—button for starting/stopping the replay of an advertisement
26—application
28—enhanced advertising facilitator
30—step of engaging services from an advertising facilitator
32—step of engaging services from a referendum service provider
34—step of requesting a site
36—step of requesting an advertisement
38—step of sending a token
39—step of requesting a referendum
40—step of caching a token
42—step of presenting an advertisement to user device
43—step of presenting a referendum to user device
44—step of displaying advertisement in user device
45—step of displaying referendum in user device
46—step of clicking a button to play the advertisement
48—step of notifying advertising facilitator of an intent to play the advertisement
50—step of initiating the advertisement
52—step of playing the advertisement
54—step of comparing tokens
56—step of notifying advertising facilitator that referendum result was collected
57—step of compensating advertising facilitator due to the impression of an advertisement
58—step of compensating advertising facilitator due to the replay of an advertisement
59—step of compensating referendum service provider
60—step of selecting a referendum answer
62—step of sending the referendum answer to referendum service provider
64—step of receiving referendum answer
66—computing device
68—mobile computing device
70—display of mobile computing device
72—step of requesting a referendum list
74—step of sending a referendum list
76—step of receiving a first token where the first token represents the display of a referendum
78—step of receiving a second token, where the second token represents the receipt of a referendum answer
80—step of comparing first and second tokens
82—step of compensating referendum service provider by advertiser
84—step of starting a timer
85—step of indicating a problem
86—step of stopping the timer started in step 84
88—step of timer expiring
90—step of sending a reward
92—step of displaying a reward

### PARTICULAR ADVANTAGES OF THE INVENTION

The present referendum system and method provides a means for engaging users. It further provides a means for engaging users that is different than currently available advertisements. It further provides a means to combine the acknowledgment of viewing of the contents of display with the submission of a referendum result. Therefore, advertisers can use referendums to promote their products and/or services while receiving referendum results for further analysis. Referendum service providers or advertisement facilitators may increase their revenue by providing additional services to advertisers to increase viewership and collect and provide advertisers with referendum results simultaneously. Advertisers may also utilize referendums to imply viewership of advisements to which they are coupled. Advertisers may also combine the use of referendums and advertisements to increase viewership of the advertisements and/or the referendums. In one embodiment, the present invention provides a means to relate the viewing of an advertisement to a means for communicating reward through a referendum. Therefore, a mutually beneficial relationship is formed between an advertisement and a referendum.

### DETAILED DESCRIPTION OF A PREFERRED EMBODIMENT

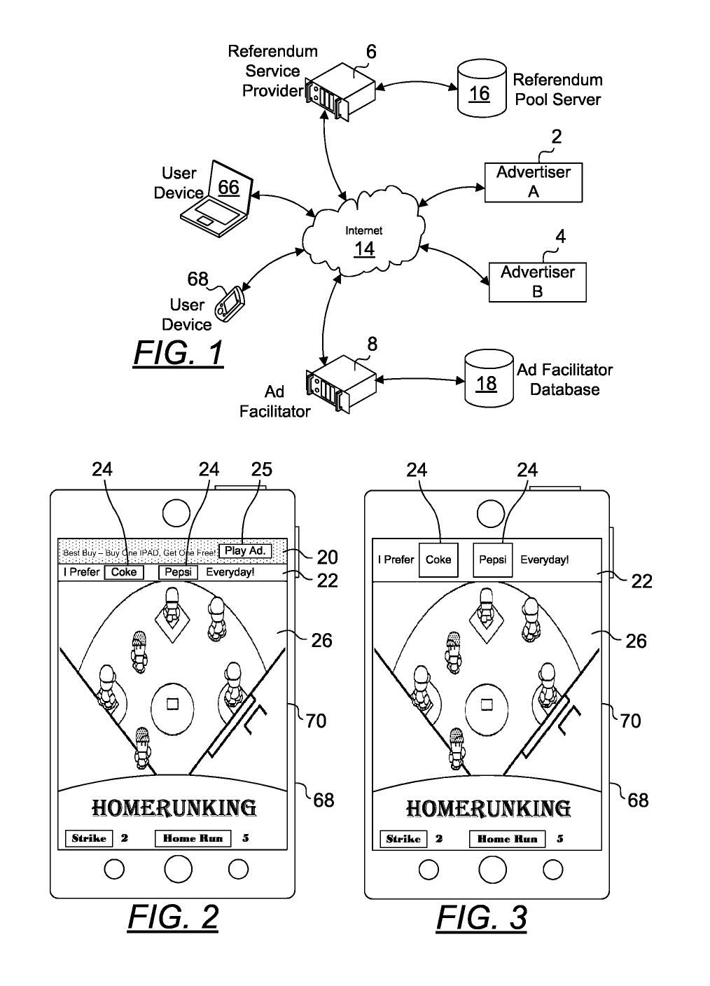

FIG. 1 is a block diagram depicting one embodiment of an exemplary advertising system utilizing a combined display of advertisements and referendums. In one aspect, an advertiser can be any entity interested in conveying information to and/or collecting information from the general public, specifically those using user devices including any computer devices, internet devices, web browsers, web applications, game interfaces, etc. In this example, advertiser A 2 includes a business entity interested in using video advertising to promote products or services. Advertiser B 4 includes a business entity interested in using referendums to promote products or services or understand market needs. A referendum service provider 6 is a business entity that serves referendums to users, collects and/or analyzes data from users in connection with served referendums and provides raw or analyzed data to advertiser B 4. An advertising facilitator 8 is a provider that serves advertisements to users and serves as a central point which advertisers engage advertising or referendum services. Examples of software applications that run in user interfaces include advertising facilitators such as search engines and game applications. Exemplary search engines include Google®, Yahoo® and Bing® while exemplary game applications include Angry Birds®, Plants vs. Zombies®, Cut the Rope® and the like. Typically within each search engine or game application, there exists an advertising component which aids in generating revenue. An example of the advertising component is the Google Adwords™ program. In Google Adwords, an advertiser may prepay for advertisements to be served or the advertiser may incur charges which will be invoiced periodically. Each advertising facilitator 8 serves as a central point where advertisers connect with users and each advertising facilitator 8 gets paid directly by advertisers 2, 4. As depicted in FIG. 1, a referendum service provider 6 is a service disposed outside of the advertising facilitator 8. The referendum service provider 6 is coupled with a referendum pool server 16. Reference is made to the disclosure of referendum pool servers of the Applicant's co-pending application Ser. No. 13/211,397, which is hereby incorporated by reference as though set forth in full herein for its teaching regarding referendum pool servers. The referendum service provider 6 is also coupled with user devices 66, 68, advertisers 2, 4 and advertising facilitator 8 through a network such as the internet 14.

As will be appreciated by those skilled in the relevant art(s) after reading the description herein, in an aspect, the user devices 66, 68 are essentially web applications executing on web servers such as the referendum service provider 6 and advertising facilitator 8 and providing one or more websites which send out web pages in response to Hypertext Transfer Protocol (HTTP) or Hypertext Transfer Protocol Secured (HTTPS) requests from remote browsers residing in user devices 66, 68. Thus, the referendum service provider 6 and advertising facilitator 8 are able to provide a graphical user interface (GUI) to remote browsers of devices 66, 68 or other devices utilizing the web application of the referendum service provider 6 and advertising facilitator 8 in the form of web pages. These web pages are sent to devices 66, 68 and result in the GUI screens being displayed.

As used herein, a user device is a generic term to represent a computing device 66 or mobile device 68 or any other interfaces which provides a hardware interface which displays advertisements or referendums to a user. The front end software serving as the front end to connect users to advertisers 2, 4 include web browsers, general applications, game applications, etc. A user includes any target audience of advertisers 2, 4. The advertising facilitator 8 is a coupled with a database 18 configured for storing advertisements submitted by advertisers 2, 4.

FIG. 2 depicts an exemplary combined display of advertisements and referendums on a mobile computing device 68. The mobile computing device 68 includes a smart phone or other smart devices such as an iPOD®, iPAD®, e-reader, tablet or any other devices capable of functional connection with an advertising facilitator and/or a referendum service provider via a network. The mobile computing device 68 includes a generally rectangular touch screen type display 70 for prominently displaying contents and receiving inputs from a user. An advertisement 20 entitling “Best Buy—Buy One iPAD®, Get One Free” is shown in the form of a banner and disposed on a top portion of the display 70. Immediately below the advertisement 20, a referendum 22 banner soliciting a response with respect to a drink is displayed, i.e., “I Prefer Coke® or Pepsi® Everyday!” The referendum is also configured as a banner. The subject matter of the advertisement 20 can be configured to relate to the subject matter of the referendum 22 banner or a referendum can be selected randomly without any relevance to the advertisement displayed alongside the referendum. In this example, the advertisement lacks any relevance to the referendum as a store called Best Buy® retails electronic goods while a drink choice or answer 24 between “Coke” and “Pepsi” is solicited. In this example, the main content of the display 70 is an application 26 called “HOMERUNKING” capable of network (e.g. internet) connection to an advertising facilitator and a referendum service provider and takes up a good portion of the display 70.

FIG. 3 depicts an exemplary display of referendum on a mobile computing device 68 wherein only a referendum 22 is displayed on the top portion of the display 70. Although a referendum enhances the value of an advertisement by providing additional contents to a display, in one present embodiment, a referendum 22 is displayed without an advertisement 20 alongside it.

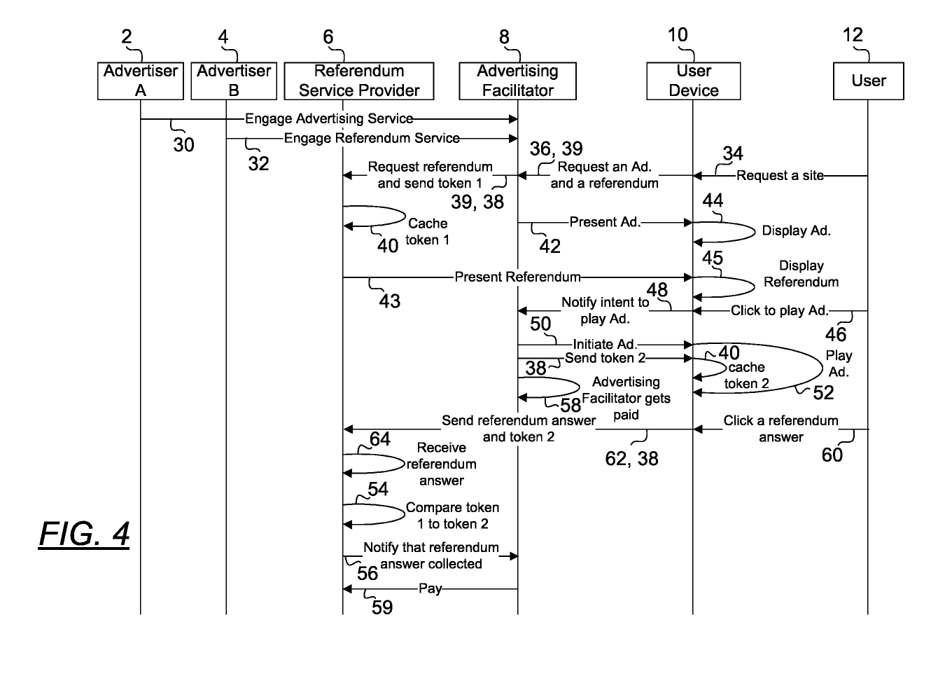

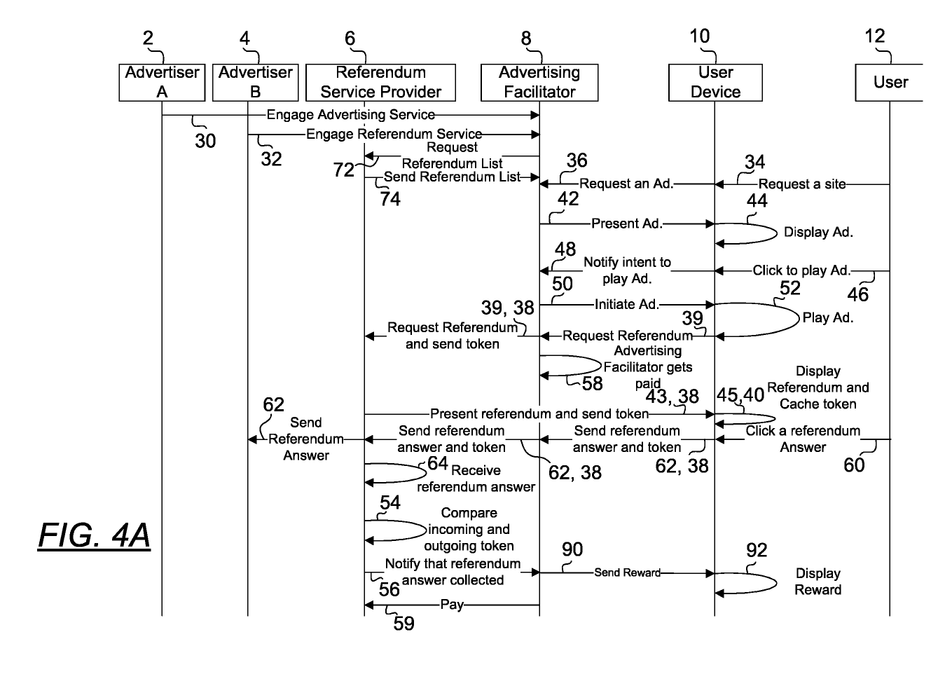

FIG. 4 is a sequence diagram depicting an exemplary advertising payment system where a referendum service provider 6 and an advertising facilitator 8 are operably distinct systems. The advertising facilitator 8 serves as a central point for providing both advertisements and referendums such that advertisers only need to contact one source for both advertisement and referendum services. As depicted in steps 30 and 32, both advertisers A 2 and B 4 engage services provided by the advertising facilitator 8 directly. These steps include selecting conditions which cause the advertisements or referendums to be displayed and payment arrangements between the advertisers 2, 4, referendum service provider 6 and advertising facilitator 8. As an example, advertiser A 2 may choose to have the following referendum question displayed if a relevant topic of U.S. presidency is searched in the advertising facilitator 8:

### “Election 2012: Obama or Romney?”

### Choice 1: Obama

### Choice 2: Romney

As a user 12 requests a site from a user device 10 as depicted in step 34, a request for an advertisement and a referendum is in turn generated and transmitted by the user device 10 and received by the advertising facilitator 8 as depicted in step 36, 39. A request for a referendum and a first token is in turn generated and transmitted by the advertising facilitator 8 and received by the referendum service provider 6 as depicted in step 39, 38. Upon receipt, the first token is cached as in step 40. Such token indicates an advertiser's commitment to compensate the referendum service provider 6 and the advertising facilitator 8. When the delivery of a referendum has been consummated (as indicated by comparing incoming and outgoing tokens), the referendum service provider 6 can then be compensated with a payment. In one embodiment, a token is an alphanumeric string. Such a token provides a unique string which can be used to confirm the delivery of a referendum.

In one embodiment, a list of referendums has to be communicated to the advertising facilitator 8 such that it can determine the referendum to be served to the user device 10 as a response to a request shown in step 36, 39 from the user device 10. In another aspect, the request of a referendum can simply imply a request for a random referendum. In this case, the referendum service provider 6 determines the referendum to be served. In one embodiment, the teachings of Applicant's co-pending application Ser. No. 13/211,397 with respect to the means by which a referendum is selected to be presented is incorporated in the advertising facilitator and is hereby incorporated in its entirety.

As a response to the request shown in step 36, 39, the advertising facilitator 8 presents an advertisement (step 42) to user device 10, where the advertisement is displayed as in step 44. As a response to the request 39, 38, the referendum service provider 6 then presents the requested referendum as shown in step 43 to the user device 10, where the referendum is displayed as in step 45. Under circumstances where the user 12 chooses to ignore the presented advertisement and referendum, there will be no further actions taken by the referendum service provider 6 and advertising facilitator 8 with respect to the presented advertisement and referendum.

In the case depicted, the user 12 is shown to respond to the advertisement by clicking a button to play the advertisement as shown in step 46. The user device 10 then notifies the user's intent to play the advertisement as shown in step 48. The advertising facilitator 8 then initiates the advertisement previously presented to the user device 10 as shown in step 50. The advertisement then plays on the user device 10 (step 52). The advertising facilitator 8 sends a second token in step 38 to the user device 10. The second token is then cached in step 40.

FIG. 4 depicts a pay per click (PPC) advertising system as the advertising facilitator 8 is only compensated when the user 12 clicks to play the advertisement. Step 58 shows the advertising facilitator 8 getting compensated as a result of the advertisement being clicked. Preferably the footprint of the advertisement remains unchanged, i.e., the advertisement is played within the space previously allocated for the display of the advertisement. It is also preferably persistent per each request of advertisement, i.e., the advertisement stays displayed after it has finished being played until the next request for an advertisement has been received. FIG. 4 shows that the user continues to click on an answer of the referendum as shown in step 60. As a result, the referendum answer and the cached second token are transmitted to the referendum service provider 6 as shown in step 62, 38. The referendum service provider 6 then receives the referendum answer in step 64. In its simplest form, the second token is identical to the first token. However, various validation operations may be applied to the first token to generate a second token which is modified from the first token but retains the signature of the first token.

The first and second tokens are then compared in step 54. If the first and second tokens are equivalent, the advertising facilitator 8 is notified of this comparison in step 56. Upon receiving this notification, the advertising facilitator 8 then compensates the referendum service provider 6 with a portion of the proceeds collected in step 32 in step 59. FIG. 4 depicts a mechanism by which an advertising facilitator 8 can validate that a referendum service has been rendered by the referendum service provider 6 such that the referendum service provider 6 can be compensated based on a PPC scheme.

Applicant discovered that under some circumstances, an advertisement can be tightly coupled with a referendum to form a mutually beneficial relationship. FIG. 4A is a sequence diagram depicting an exemplary advertising payment system which relates the viewing of an advertisement to a means for communicating a reward through a referendum. It will be apparent, upon viewing the ensuing description for FIG. 4A that the following benefits are obtained:
(1) The viewership of an advertisement is increased by the expectation of a reward which is communicated via a referendum;
(2) The participation in a referendum is increased as the means for receiving an answer for the referendum is also the means by which the reward is communicated;
(3) The referendum advertiser can increase statistical data collection by increased participation of the referendum; and
(4) Advertisers' confidence in using advertisements and referendums is increased.

The advertising facilitator 8 again serves as a central point for providing both advertisements and referendums. As depicted in steps 30 and 32, both advertisers A 2 and B 4 engage services provided by the advertising facilitator 8 directly. As the coupling between the referendum service provider 6 and the advertising facilitator 8 is increased, the advertising facilitator 8 may require additional information to more intelligently pair an advertisement to a referendum. This is accomplished by providing a referendum list to the advertising facilitator 8 as shown in step 74. The advertising facilitator 8 requests a referendum list in step 72. In response, the referendum service provider 6 sends a referendum list to the advertising facilitator 8. As a user 12 requests a site from a user device 10 in step 34, a request for an advertisement is in turn generated and transmitted by the user device 10 and received by the advertising facilitator 8 in step 36. As a response to the request, an advertisement is presented to the user device 10 in step 42, where the advertisement is displayed as in step 44. This is followed by the user 12 clicking a button to play the advertisement in step 46. The user device 10 then notifies the user's intent to play the advertisement in step 48. In step 50, the advertising facilitator 8 then initiates the advertisement previously presented to the user device 10. The advertisement then plays on the user device 10 (step 52). The key difference between FIGS. 4A and 4 lies in a subsequent request for a referendum as shown in step 39 in response to the completion of step 52. This in turn causes a request for a referendum and a token to be sent to the referendum service provider 6 as shown in step 39, 38. As a response to the request in step 39, 38, the first token is sent alongside a referendum by the referendum service provider 6 to the user device 10 as shown in step 43, 38, where the referendum is displayed as in step 45 and the token cached as in step 40. Step 58 shows the advertising facilitator 8 getting compensated as a result of the advertisement being clicked. The user continues to click an answer of the referendum as shown in step 60. As a result, the referendum answer and token are transmitted to the advertising facilitator 8 as shown in step 62, 38. The referendum answer and token are subsequently transmitted to the referendum service provider 6 as shown in step 62, 38. The referendum service provider 6 then receives the referendum answer as shown in step 64. The referendum answer is sent to advertiser B 4 which utilizes referendum services of the advertising facilitator 8. In step 54, the outgoing first token in step 43, 38 is compared to the token of step 62, 38. If the two tokens are equivalent, the advertising facilitator 8 is notified of this comparison as shown in step 56. Upon receiving this notification, the advertising facilitator 8 then compensates the referendum service provider 6 with a portion of the proceeds collected in step 32 in step 59. In step 90, the advertising facilitator 8 transmits a reward which is displayed at the user device 10 as shown in step 92. In step 62, the referendum answer selected by the user 12 is transmitted from the referendum service provider 6 to advertiser B 4. In one embodiment, the reward is a discount coupon code usable in a specific product purchase. In another embodiment, the reward is a game decoder usable to decode an online game.

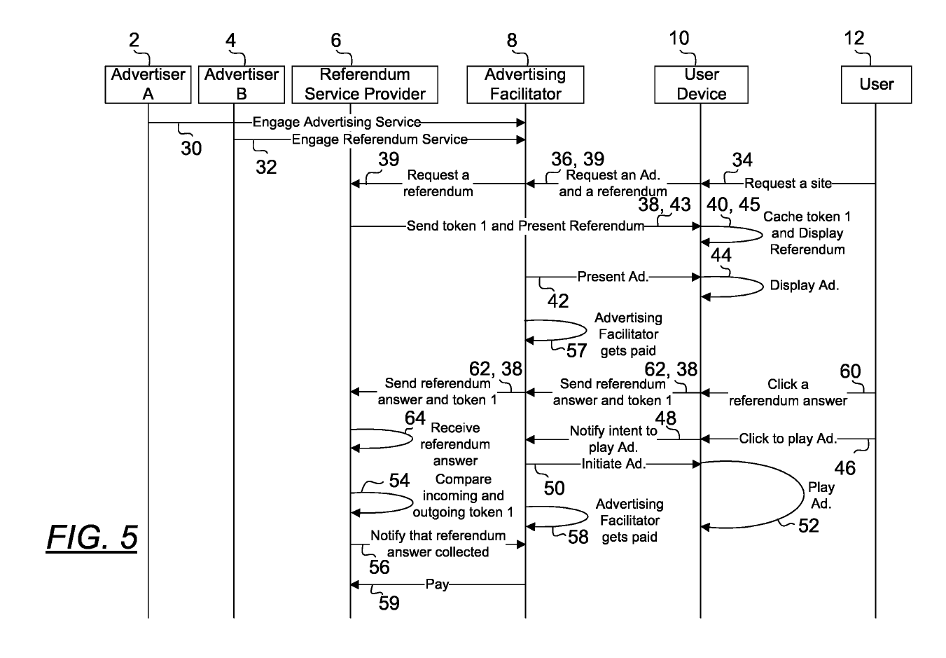

FIG. 5 is a sequence diagram depicting an exemplary advertising payment system with alternate handshakes between a user device 10, an advertising facilitator 8 and a referendum service provider 6 where a referendum service provider 6 and an advertising facilitator 8 are operably distinct systems. The advertising facilitator 8 also serves as a central point for providing both advertisements and referendums such that advertisers only need to contact one source, i.e., the advertising facilitator 8 for both advertisement and referendum services. As depicted in steps 30 and 32, both advertisers A 2 and B 4 engage services provided by the advertising facilitator 8 directly. As a user 12 requests a site from a user device 10 as depicted in step 34, a request for a referendum and an advertisement is in turn generated and transmitted by the user device 10 and received by the advertising facilitator 8 as depicted in step 36, 39. A request for a referendum is in turn generated and transmitted by the advertising facilitator 8 and received by the referendum service provider 6 as depicted in step 39. As a response to the request shown in step 39, a first token is sent alongside a referendum by the referendum service provider 6 to the user device 10 in step 38, 43. The token is then cached and the referendum displayed on the user device 10 as shown in step 40, 45.

In contrast to the referendum mechanism depicted in FIG. 4, the referendum selection decision originates from the referendum service provider 6 directly as indicated by the origin of the token. Increased autonomy of the referendum to be served is given to the referendum service provider 6. As a response to the request shown in step 39, an advertisement is also presented to the user device 10 as shown in step 42, where the advertisement is displayed in step 44. Step 57 shows the advertising facilitator 8 getting compensated as a result of the advertisement being displayed. In this example, the advertising facilitator 8 is paid via PPI as well as PPC. After both the advertisement and referendum have been presented at the user device 10, the user 12 is now able to interact with one or both of these displays. FIG. 5 shows that the user continues to click on an answer of the referendum in step 60. As a result, the referendum answer and the token are transmitted to the advertising facilitator 8 as shown in step 62, 38. The advertising facilitator 8 in turn sends the referendum answer and the token in step 62, 38 to the referendum service provider 6. The referendum service provider 6 then receives the referendum answer in step 64. This is followed by the user 12 clicking a button to play the advertisement in step 46. The user device 10 then notifies the user's intent to play the advertisement as shown in step 48. The advertising facilitator 8 then initiates the advertisement previously presented to the user device 10 in step 50. The advertisement then plays on the user device 10 (step 52). Step 58 shows the advertising facilitator getting compensated as a result of the advertisement being clicked. The outgoing token of step 38, 43 is compared to the token of step 62, 38. If the two tokens are equivalent, the advertising facilitator 8 is notified of this comparison in step 56. Upon receiving this notification, the advertising facilitator 8 then compensates the referendum service provider 6 with a portion of the proceeds collected in step 32 as shown in step 59.

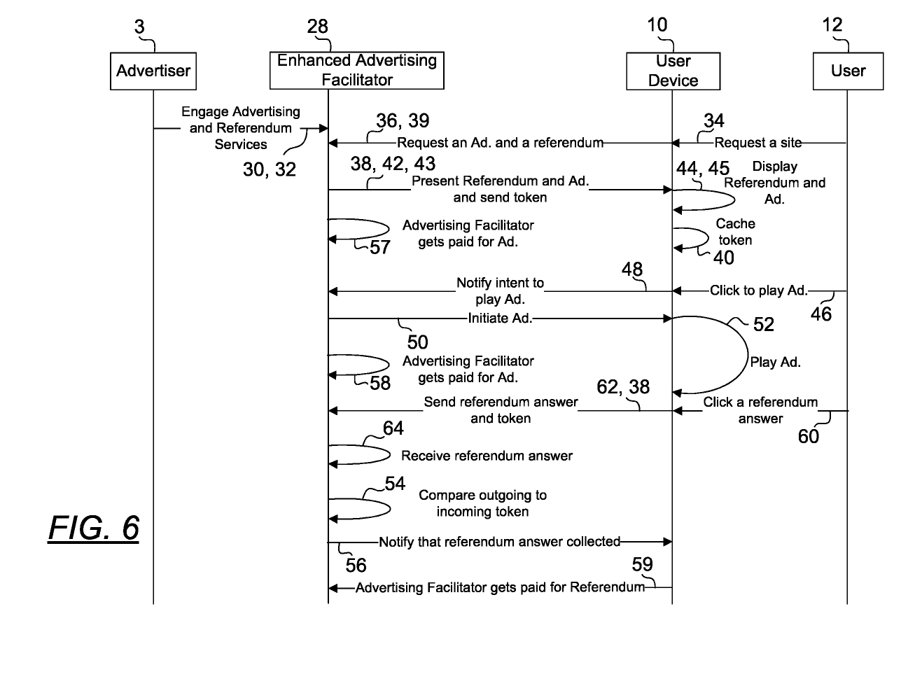

FIG. 6 is a sequence diagram depicting an exemplary advertising payment system where a referendum service provider is configured integrally with an advertising facilitator to form an enhanced advertising facilitator 28. An advertiser 3 wishing to engage both advertising and referendum services may contact the enhanced advertising facilitator directly via step 30, 32. As a user 12 requests a site from a user device 10 in step 34, a request for both an advertisement and a referendum is in turn generated and transmitted by the user device 10 and received by the enhanced advertising facilitator 28 in step 36, 39. As a response to the request in step 36, 39, a referendum, an advertisement and a token are presented to the user device 10 as shown in step 43, 42, 38, where the advertisement is displayed as in step 44 and the referendum is displayed as in step 45. The token is then cached as shown in step 40. The enhanced advertising facilitator 28 is then compensated for displaying the advertisement as shown in step 57. This is followed by the user 12 clicking a button to play the advertisement as shown in step 46. The user device 10 then notifies the enhanced advertising facilitator 28 the user's intent to play the advertisement in step 48. The enhanced advertising facilitator 28 then initiates the advertisement (step 50) previously presented to the user device 10 in step 43, 42, 38. The advertisement then plays on the user device 10 (step 52). Step 58 shows the advertising facilitator getting compensated as a result of the advertisement being played. The user continues to click an answer of the referendum as shown in step 60. As a result, the referendum answer and a token are transmitted to the enhanced advertising facilitator 28 as shown in step 62, 38. The enhanced advertising facilitator 28 then receives the referendum answer in step 64. In step 54, the outgoing token as shown in step 38, 42, 43 is compared to the token of step 62, 38. If the two tokens are equivalent, the advertising facilitator 8 is notified of this comparison as shown in step 56. Upon receiving this notification, the advertising facilitator 8 then compensates the referendum service provider 6 with a portion of the proceeds collected in step 32 as shown in step 59.

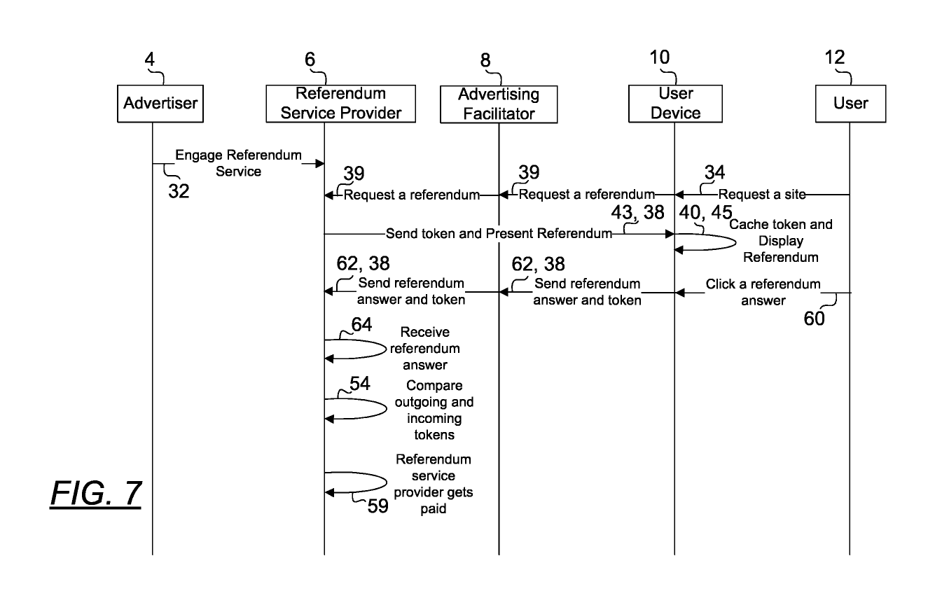

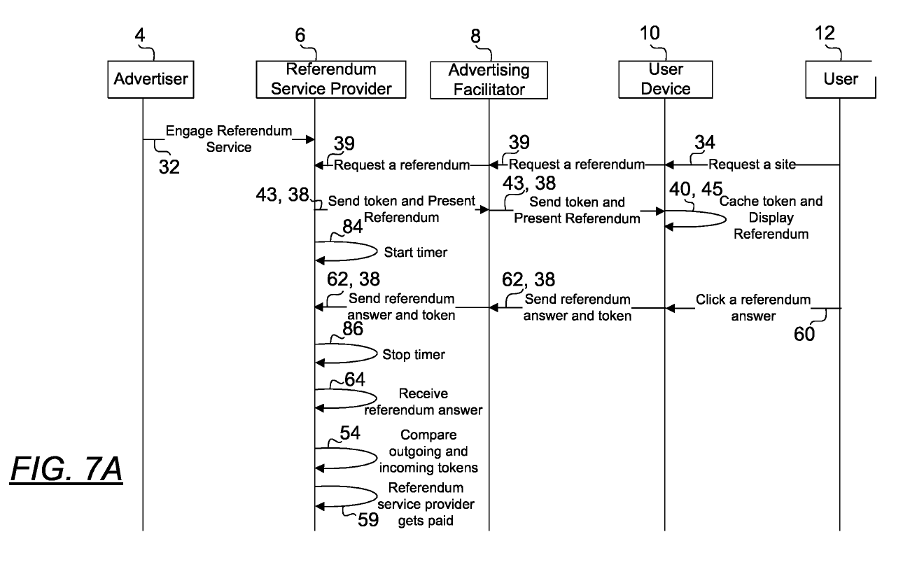

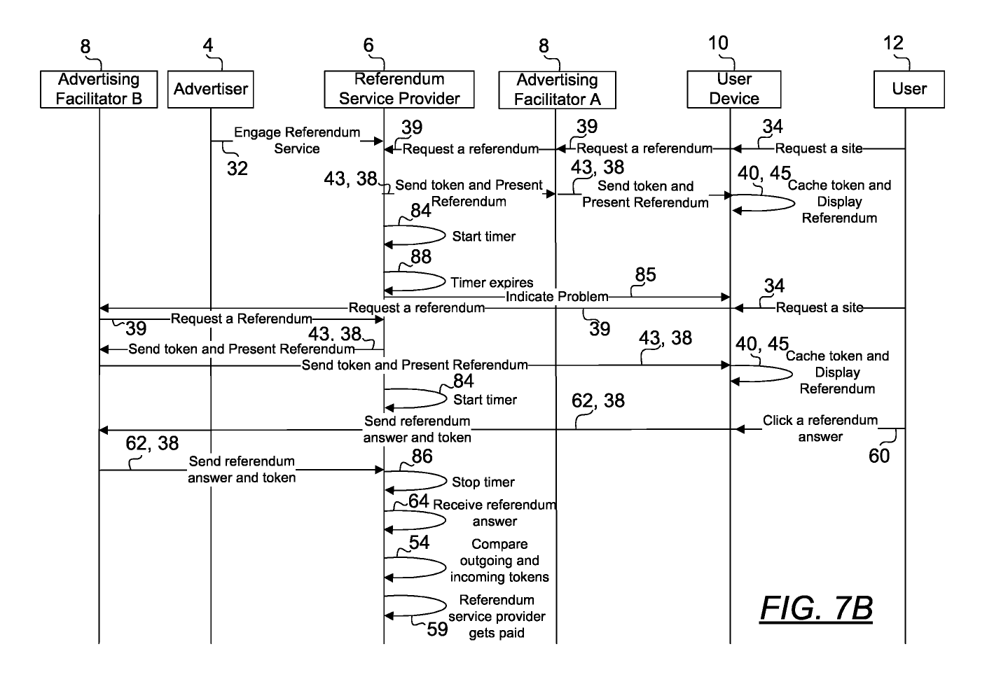

FIG. 7 is a sequence diagram depicting a referendum service of an exemplary advertising payment system. As a user 12 requests a site from a user device 10 as depicted in step 34, a request for a referendum is in turn generated and transmitted by the user device 10 and received by the advertising facilitator 8 in step 39. As a response to the request in step 39, a referendum and a token are presented to the user device 10 in step 43, 38, where the token is cached in step 40 and the referendum is displayed in step 45. The user continues to click on an answer of the referendum as shown in step 60. As a result, the referendum answer and the token are transmitted to the advertising facilitator 8 in step 62, 38. The advertising facilitator 8 in turn sends the referendum answer and the token as in step 62, 38 to the referendum service provider 6. The referendum service provider 6 then receives the referendum answer as shown in step 64. In step 54, the outgoing token of step 43, 38 is compared to the token of step 62, 38. The referendum service provider 6 is then compensated with a portion of the proceeds collected in step 32 as shown in step 59.

FIG. 7A is a sequence diagram depicting a referendum service of yet another exemplary advertising payment system. In this embodiment, as a response to the request in step 39, a referendum and a token are first transmitted to the advertising facilitator 8 as in step 43, 38. The referendum and the token are then presented to the user device 10 in step 43, 38. As compared to FIG. 7, all communications between a referendum service provider 6 and a user device 10 as depicted in FIG. 7A are routed through an advertising facilitator 8. As such, the referendum service provider 6 is free from exposure to abuse such as Denial of Service (DoS) or Distributed DoS (DDoS). Any internet connection to the referendum service provider 6 represents an opportunity for launching an attack. From the perspective of the referendum service provider 6 as shown in FIG. 7A, such opportunity for attack is limited in scope to the advertising facilitator 8. In one configuration, a referendum service provider 6 may choose to interact with more than one advertising facilitator 8. Should an advertising facilitator 8, configured to facilitate interactions between the referendum service provider 6 and a user device 10 be compromised, the referendum service provider 6 may choose to conduct referendums via another advertising facilitator 8 to minimize referendum service outage. A lack of a response from the user 12 within a period of time after a referendum has been presented can indicate one of a number of problems, i.e., (a) A DoS or DDoS attack on the advertising facilitator 8, (b) User refusal in selecting or sending a response, and (c) User device 10 is not functioning properly, etc. If desired, a timing scheme can be used (as shown in FIG. 7A) to detect the lack of response within a time period from a user 12 and to channel referendums to one or more other advertising facilitators. A timer is started (as in step 84) upon sending a token and referendum to the advertising facilitator 8. If a referendum and token are received within a predetermined time period, the timer is stopped (as in step 86). Otherwise, the timer continues until it expires (as in step 88 of FIG. 7B).

FIG. 7B is a sequence diagram depicting a referendum service of FIG. 7A wherein a second advertising facilitator is used to serve referendums in case the first advertising facilitator is compromised. In this case, the referendum service provider 6 may choose based on an advertiser's preference, to divert referendum advertising resources to a different advertising facilitator should one advertising facilitator fails. A timer is started in step 84 to safeguard against lack of response from the user. A lack of user respond can indicate the user's refusal to participate in the referendum or the advertising facilitator has been compromised. After the timer expires (as in step 88), a message is transmitted directly from the referendum service provider 6 to the user device 10 as shown in step 85 to indicate a problem. An example message is shown as follows:

“A referendum answer has not been received. If your Advertising Facilitator or Web Browser hangs, please try another Advertising Facilitator or Web Browser.”

Upon selecting a second advertising facilitator, the next request for a site from the user 12 causes a request for a referendum to be sent to the second advertising facilitator, i.e., “Advertising Facilitator B.” The process then continues according to the steps in FIG. 7A with Advertising Facilitator B. The risk that a referendum cannot be served is therefore minimized. In one embodiment, the timer ranges from about 10 seconds to about 60 seconds.

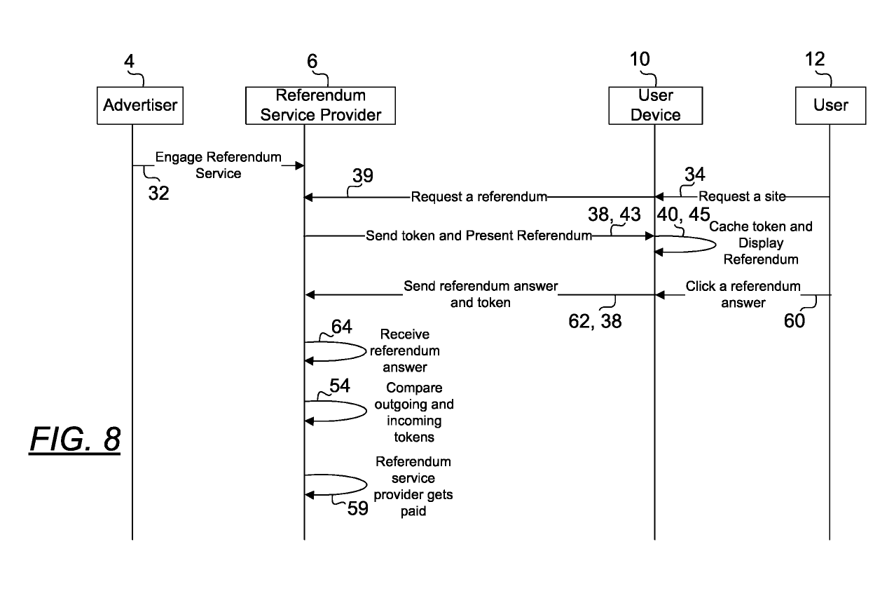

FIG. 8 discloses a case where the advertising facilitator 8 receives a referendum request directly from the user device 10. In FIG. 7, the advertising facilitator 8 determines whether the request is passed directly on to the referendum service provider 6 or modified before passing on to the referendum service provider 6. In another embodiment as depicted in FIG. 8, this option is not available. FIG. 8 is a sequence diagram depicting a referendum service provider 6 which operates independently from an advertising facilitator 8.

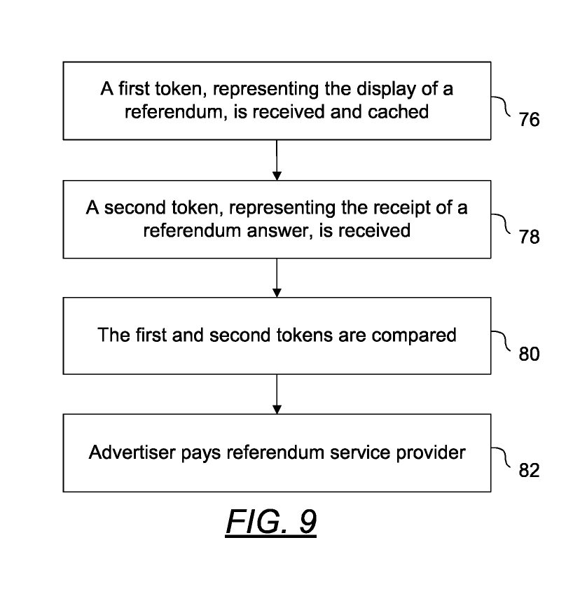

FIG. 9 is a flowchart summarizing a means for monetizing a referendum as depicted in FIGS. 4 through 8. In step 76, a first token which represents the display of a referendum on a user interface is first received by a referendum service provider or its equivalent entity. In step 78, a second token which represents the receipt of a referendum answer is received by a referendum service provider or its equivalent entity. The first and second tokens are then compared as shown in step 80. A token serves a means by which a referendum can be proven to have been conducted. For instance, the first and second tokens may be a string including alphanumeric characters as follows:

### “XTY19XY63”

A token can be transmitted through a network (for e.g. internet) in the header or data field of a user message between the user device 10, referendum service provider 6, advertising facilitator 8 and advertisers 2, 4.

I claim:

1. A method for generating revenue by a referendum service provider, wherein at least one advertiser utilizes said referendum service provider to provide a referendum through a user interface and said referendum includes at least two answers, one of which is to be selected, said method comprising:
(a) receiving and storing a first token generated as a result of a request for a referendum to be displayed on said user interface;
(b) receiving a second token generated as a result of the selection of one of said two answers; and
(c) comparing said first token to said second token to produce a result, wherein if said result indicates a match, said referendum service provider is compensated with a compensation by said at least one advertiser.

2. The method of claim 1, wherein said referendum service provider is engaged directly by said at least one advertiser.

3. The method of claim 2, wherein said compensation is provided directly to said referendum service provider by said at least one advertiser as a result of engagement of service provided by said referendum service provider.

4. The method of claim 1, wherein said referendum service provider is engaged by an advertising facilitator which is in turn engaged by said at least one advertiser.

5. The method of claim 4, wherein said compensation is provided directly to said advertising facilitator by said at least one advertiser and a portion of said compensation is shared with said referendum service provider as a result of engagement of service provided by said referendum service provider to said advertising facilitator.

6. The method of claim 1, wherein each of said first and second tokens is an alphanumeric string.

7. A method for conducting a referendum alongside a content on a user interface, wherein said referendum is selected based on said content and said referendum includes at least two answers, one of which is to be selected, said method comprising:
(a) an advertiser engaging a referendum service provider to respond to a request for a referendum to be displayed on said user interface;
(b) receiving a request from a user for a content, wherein said referendum corresponds to said content;
(c) displaying said content;
(d) receiving and storing a first token generated as a result of a request from said user for a referendum;
(e) displaying said referendum alongside said content;
(f) receiving a second token generated as a result of the selection of one of said two answers; and
(g) comparing said first token to said second token to produce a result, wherein if said result indicates a match, the provider of said referendum is compensated.

8. The method of claim 7, further comprising displaying an advertisement alongside said referendum.

9. The method of claim 8, wherein said advertisement comprises a video advertisement.

10. The method of claim 9, wherein steps (d)-(g) are executed only after said video advertisement has been played.

11. The method of claim 7, wherein said request from said user for a referendum is communicated to an advertising facilitator, said request is in turn communicated to a referendum service provider configured for satisfying said request for a referendum such that said referendum service provider is isolated from potential abuse exerted on said advertising facilitator.

12. The method of claim 7, further comprising a step of rewarding said user with a reward.

13. The method of claim 12, wherein said reward is selected from the group consisting of a discount coupon code and a game decoder.

14. The method of claim 7, wherein each of said first and second tokens is an alphanumeric string.

15. A system for monetizing referendums presented to a user at a user device, said system comprising:
(a) a referendum pool server for storing referendums;
(b) a referendum service provider configured to serve a referendum requested by said user by accessing said referendum stored in said referendum pool server; and
(c) an advertising facilitator configured to receive a referendum service engagement from at least one advertiser, said advertising facilitator is configured to act as an interface between said referendum service provider and said user such that a request by said user for said referendum to be placed on said user device and said referendum selected for meeting said request by said user are routed through said advertising facilitator,
wherein said referendum service provider is configured to be compensated by said advertising facilitator upon receiving an answer corresponding to said referendum from said user device.

16. The system of claim 15, wherein said advertising facilitator is further configured to serve at least one advertisement on said user device.

17. The system of claim 16, wherein said at least one advertisement is a video advertisement.

18. The system of claim 16, wherein said referendum is displayed alongside said advertisement.

19. The system of claim 17, wherein said referendum service provider is compensated only upon the conclusion of said video advertisement.

20. The system of claim 15, wherein said user is presented a reward at said user device upon having provided an answer to said referendum requested by said user.
